(19) United States
(12) Patent Application Publication
(10) Pub. No.: US 2008/0171823 A1
(43) Pub. Date: Jul. 17, 2008

(54) SINGLE COMPONENT FLAME RETARDANT ADDITIVE FOR POLYMERS USING NANOTUBES

(75) Inventors: Miriam Rafailovich, Plainview, NY (US); Mayu Si, East Islip, NY (US)

Correspondence Address: THE FARRELL LAW FIRM, P.C., 333 EARLE OVINGTON BOULEVARD, SUITE 701, UNIONDALE, NY, 11553, US

(73) Assignee: The Research Foundation of State University of New York, Albany, NY (US)

(21) Appl. No.: 11/834,060

(22) Filed: Aug. 6, 2007

Related U.S. Application Data
(60) Provisional application No. 60/836,436, filed on Aug. 8, 2006.

(51) Int. Cl. C09K 21/14; C09K 21/02; D01F 9/12

(52) U.S. Cl. 524/495; 423/447.2; 252/609

(57) ABSTRACT

The invention is directed to a flame retardant additive comprising carbon based nanotudes having flame retardant properties. The flame retardant additive of the invention includes up to about 25% by weight of the carbon-based nanotube. An embodiment of the invention is directed to a polymer including the flame retardant additive of the invention which comprises an effective amount of carbon based nanotubes. The invention also relates to a method of improving the flame retardant properties of a material, the method including adding to the material an effective amount of the flame retardant additive of the invention.

This application claims priority to a provisional patent application filed with the U.S. Patent and Trademark Office on Aug. 8, 2006, and assigned application Ser. No. 60/836,436, the contents of which is incorporated herein by reference.

### FIELD OF THE INVENTION

This invention relates to carbon based nanotube flame retardant additives for polymers such as polyurethane foams and/thermoplastics.

### BACKGROUND OF THE INVENTION

Flame retardants are incorporated into many products for safety in efforts to control the spread of fire through the product. Flame retardants can, for example, act by causing rapid extinguishing of flames, or by making the product difficult to set afire. While flame retardants have conventionally been used to treat fabrics, soft furnishings, etc. and have been incorporated into foams, paints, and resins such as epoxy resins, many other applications are now being actively pursued, especially within the electronic, automotive, aerospace and construction industries.

Although useful in providing flame retardant properties in polymers like thermoplastics, known phosphonate, halogenated, metallic flame retardant additives have disadvantages that limit their use. The present invention provides a carbon nanotube based flame retardant additive that avoids the disadvantages of the known phosphonate, halogenated, metallic flame retardant additives to provide useful compositions.

One disadvantage of the known phosphonate flame retardant additives is that the known flame retardant additives impart a variety of performance problems and other deficiencies to the thermoplastic composition. These problems can limit or eliminate their usefulness with some polymers such as thermoplastics and in particular, polyolefins. Off-gassing and liquid bleed out in particular have been found in these thermoplastic systems, and these disadvantages are believed to have been caused by phosphonate salt/synergist interactions.

Halogenated flame retardant additives are being used less and less in the market since data shows that the halogentaed compounds may have detrimental affects on the environment. In fact, some states outlaw the use of these compounds. Many metallic compounds are often found to detrimentally affect the environment and are being phased out of the market.

In addition, many conventional flame retardant additives have been found to have a tendency to migrate and/or volatilize from the polymers they are added to over time. The migration of the flame retardant additive causes the object to eventually lose its flame retardant properties. Yet another disadvantage of known phosphonate flame retardants additives are their hygroscopic properties, which will cause thermoplastic objects incorporating these additives to absorb moisture or water over time. Furthermore, the known phosphonate flame retardant additives have poor thermal stability. The additives are known to decompose at various polymer/thermoplastic processing temperatures, and particularly during the thermoplastic extrusion process.

The present invention overcomes the disadvantages of conventional additives by providing a more stable carbon based nanotube flame retardant additive for use in polymers.

### SUMMARY OF THE INVENTION

The invention provides a flame retardant additive that includes carbon based nanotudes having flame retardant properties. The flame retardant additive of the invention includes up to about 25% by weight of the carbon-based nanotube.

Another embodiment of the invention provides to a polymer that includes the flame retardant additive of the invention which includes an effective amount of carbon based nanotubes. The polymer includes, but is not limited to polyolefin, polystyrene, polycarbonate, PVA, SAN, PPO, PVC, polyurethane, PMMA, EPDM, a thermoset polymer, a halogenated polymer, Teflon, acrylic polymer, silicone, Nylon, Nylon 6, polysulfone, acrylonitrile, polyamide, polyarylate, polycaprolactone, polyester-polycarbonate copolymer, polyester acrylate copolymer, polyester polyol, PEEK, polyether imide, polyether thermoset epoxy, polyether sulfone copolymer, polyethyl acetate copolymer, Rayon, vinylcycloalkane, vinyl acetate, vinyl ester, vinyl acetal, vinyl pyridine, cellulose, a cellulose derivative and mixtures thereof.

### DETAILED DESCRIPTION OF THE INVENTION

The use of flame retardants typically requires a variety of additives in order to pass flame retardant requirements for flame retardant plastics. Most of these are modified organic compounds or metal/metal oxide derivatives. In most cases, results are achieved with mixtures of two or more flame retardant additives into a polymer in order to achieve the desired result. Examples of such test requirements are the ASTM E-84 tunnel test, the UL-94 Vo through 5V. Many such additives present significant environmental and occupational safety hazards for those handling them.

The present invention provides a flame retardant additive containing carbon based nanotudes having flame retardant properties. The flame retardant additive of the invention comprises up to about 25% by weight of the carbon-based nanotube; in another embodiment up to about 10% by weight carbon-based nanotube; in another embodiment, from 0.1 to 8% and in yet another embodiment, 0.5 to 5% by weight carbon-based nanotube. It is to be understood that each of the above-ranges is not mutually exclusive, and combinations of such ranges is within the scope of the present invention. For purposes of this disclosure, flame retardant additive and flame retardant additive package may be used interchangeably.

Another embodiment of the invention provides a polymer comprising the flame retardant additive of the invention which includes an effective amount of carbon based nanotubes.

In still another embodiment, the invention provides a method for improving the flame retardant properties of a material, said method comprising adding to said material a flame retardant effective amount of the flame retardant additive of the invention.

In one embodiment of the present invention, the flame retardant additive of the invention is added to polymers, or other materials wherein improved flame retardant properties is desired in a flame retarding effective amount. An effective amount of the flame retardant additive typically ranges between 0.1-5% by weight for stand alone flame retardance property when dealing with polymers. The flame retardant additive package of the present invention can consist only of the carbon-based nanotubes in order to be 100% effective on meeting a given flame test requirement, or it can be employed in combination with other flame retardant materials. The additive is highly effective in unusually small ranges, i.e. 0.5% by weight gave a UL-94 Vo rating to all polymers tested. The flame retardant package can be applied to many different types of polymers and copolymers.

Preferably, a combination of carbon nanotubes, flame retardant formulas, and nanoclays totals less than 5% clays and 20% flame retardant formulations.

In another embodiment, the invention relates to a flame retardant additive package that comprises a combination of carbon nanotubes, flame retardant(s), and optionally, an effective amount of nanoclays. The skilled artisan is well aware of the numerous conventional flame retardant additives that can be employed in this respect, as well as the nanoclays that can be utilized. In a typical embodiment, the flame retardant additive package of the invention comprises up to 25% by weight carbon nanotubes, up to about 5% nanoclays and up to 20% conventional flame retardant formulations. In yet another embodiment, the flame retardant additive of the invention comprises from 0.1 to 8% and by weight carbon-based nanotube, from 0.1 to 5% nanoclay(s) and from 0.1 to 20%, in another embodiment, 0.5 to 15%, and in still another embodiment, 1-5% conventional flame retardant formulations.

For example, the flame retardant package of the present invention can be added to polymers or copolymers selected from the group consisting essentially of polyolefin, polystyrene, polycarbonate, PVA, SAN, PPO, PVC, polyurethane, PMMA, EPDM, a thermoset polymer, a halogenated polymer, Teflon, acrylic polymer, silicone, Nylon, Nylon 6, polysulfone, acrylontrile, polyamide, polyarylate, polycaprolactone, polyester-polycarbonate copolymer, polyester acrylate copolymer, polyester polyol, PEEK, polyether imide, polyether thermoset epoxy, polyether sulfone copolymer, polyethyl acetate copolymer, Rayon, vinylcycloalkane, vinyl acetate, vinyl ester, vinyl acetal, vinyl pyridine, cellulose, a cellulose derivativel) crosslinked or/and noncrosslinked polyamide (aromatic or non-aromatic), crosslinked polyvinyl alcohol (PVA), its crosslinked copolymers such as poly(vinyl alcohol-co-vinyl amine), cationically or anionically modified PVA, and blend with polyacrylic acid, crosslinkable polyethylene glycol crosslinked polyethylene glycol, cellulose acetate, cellulose triacetate, or the mixture of two, Chitosan or crosslinked Chitosan, crosslinked poly(hydroxyethylmethacrylate) (PHEMA), crosslinked hydroxyethyl cellulose and mixtures thereof.

As mentioned above, the high potency of the carbon-based nanotubes as flame retardants allows for the low loading and still complies with stringent flame retardancy tests. For example the carbon based nanotube flame retardant additive of the present invention allows for UL-94 ratings with as little as 0.5% by weight. Increasing loads will allow for better UL-94 Vo ratings such as UL-94 SI with about 10% by weight added to the polymer composition. These ratings can reached using the claimed invention without containing hazardous materials since carbon nanotubes have been proven safe with normal precautions. In addition, polymers containing carbon nanotubes have electrical and EMI properties as a by-product.

Although carbon based nanotubes are expensive, future widespread use will causes the price to undoubtedly decline. In addition, the high cost of the carbon based nanotubes at the present time is compensated by its high activity and low loading rates.

In general, the carbon based nanotube flame retardant of the claimed invention can be added to polymers and/or plastics, can be used to make electrically conductive flame retardant plastic and polymers and can be used produce EMI shielding materials which also have flame retardant properties. All of these fall with the inventive scope of the present invention.

In addition, Halloysite (Nautre Nano) silicate clay nanotubes were found, when soaked in a flame retardant phosphate solution with some polymers, not to require additional flame retardants.

While the present invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

What is claimed is:

1. A flame retardant additive comprising at least one carbon based nanotube.

2. The flame retardant additive of claim 1, wherein the flame retardant additive comprises up to about 25% by weight of the carbon based nanotube.

3. The flame retardant additive of claim 2, wherein the flame retardant additive comprises up to about 10% by weight of the carbon based nanotube.

4. A polymer comprising the flame retardant additive of claim 1.

5. The polymer of claim 4, wherein the polymer comprises up to 10% by weight said flame retardant additive.

6. The polymer of claim 5, wherein the polymer comprises from about 0.1-5% by weight of said flame retardant additive.

7. The polymer of claim 4 wherein the polymer is a polymer or copolymer selected from the group consisting essentially of polyolefin, polystyrene, polycarbonate, PVA, SAN, PPO, PVC, polyurethane, PMMA, EPDM, a thermoset polymer, a halogenated polymer, Teflon, acrylic polymer, silicone, Nylon, Nylon 6, polysulfone, acrylonitrile, polyamide, polyarylate, polycaprolactone, polyester-polycarbonate copolymer, polyester acrylate copolymer, polyester polyol, PEEK, polyether imide, polyether thermoset epoxy, polyether sulfone copolymer, polyethyl acetate copolymer, Rayon, vinylcycloalkane, vinyl acetate, vinyl ester, vinyl acetal, vinyl pyridine, cellulose, a cellulose derivative, crosslinked or/and noncrosslinked polyamide (aromatic or non-aromatic), crosslinked polyvinyl alcohol (PVA), its crosslinked copolymers such as poly(vinyl alcohol-co-vinyl amine), cationically or anionically modified PVA, and blend with polyacrylic acid, crosslinkable polyethylene glycol crosslinked polyethylene glycol, cellulose acetate, cellulose triacetate, or the mixture of two, Chitosan or crosslinked Chitosan, crosslinked poly(hydroxyethylmethacrylate) (PHEMA), crosslinked hydroxyethyl cellulose and mixtures thereof.

8. A flame retarded composition comprising a flame retardant additive containing up to 25% by weight of the carbon based nanotube and a melt blend polymer micro-composites with two of more polymers.

9. The flame retarded composition of claim 8 wherein the polymers are selected from the group essentially consisting of polyolefin, polystyrene, polycarbonate, PVA, SAN, PPO, PVC, polyurethane, PMMA, EPDM, a thermoset polymer, a halogenated polymer, Teflon, acrylic polymer, silicone, Nylon, Nylon 6, polysulfone, acrylontrile, polymaide, polyarylate, polycaprolactone, polyester-polycarbonate copolymer, polyester acrylate copolymer, polyester polyol, PEEK, polyether imide, polyether thermoset epoxy, polyether sulfone copolymer, polyethyl acetate copolymer, Rayon, vinylcycloalkane, vinyl acetate, vinyl ester, vinyl acetal, vinyl pyridine, cellulose, a cellulose derivative, crosslinked or/and noncrosslinked polyamide (aromatic or non-aromatic), crosslinked polyvinyl alcohol (PVA), its crosslinked copolymers such as poly(vinyl alcohol-co-vinyl amine), cationically or anionically modified PVA, and blend with polyacrylic acid, crosslinkable polyethylene glycol crosslinked polyethylene glycol, cellulose acetate, cellulose triacetate, or the mixture of two, Chitosan or crosslinked Chitosan, crosslinked poly(hydroxyethylmethacrylate) (PHEMA), crosslinked hydroxyethyl cellulose and mixtures thereof.

10. The composition of claim 8, wherein the polymer comprises up to 10% by weight said flame retardant additive.

11. The composition of claim 10, wherein the polymer comprises up to about from 0.1-5% by weight of said flame retardant additive.

12. A method of improving the flame retardant properties of a material, said method comprising adding to said material an effective amount of the flame retardant additive of claim 1.

13. The method of claim 12, wherein the flame retardant additive comprises up to about 25% by weight of the carbon based nanotube.

14. The method of claim 13, wherein the flame retardant additive comprises up to about 10% by weight of the carbon based nanotube.

15. The method of claim 14, wherein the material comprises up to 10% by weight said flame retardant additive.

16. The method of claim 15, wherein the material comprises up to about from 0.1-5% by weight of said flame retardant additive.

17. The method of claim 12 wherein said material is selected from textiles, polymers, fabrics, soft furnishings, foams, paints, resins, electronic materials, automotive materials, aerospace materials and construction materials.

18. A flame retardant additive package comprising up to about 25% by weight of the carbon based nanotube, up to about 5% by weight on one or more nanoclays and up to 20% by weight of at least one conventional flame retardant additive.

19. The flame retardant additive of claim 18 comprising from 0.1 to 10% and by weight carbon-based nanotube, from 0.1 to 5% by weight nanoclay and from 0.1 to 20% by weight conventional flame retardant.

20. A polymer comprises from about 0.1-5% by weight of said flame retardant additive package of claim 18.
